(19) United States
(12) Patent Application Publication
(10) Pub. No.: US 2023/0223546 A1
(43) Pub. Date: Jul. 13, 2023

(54) METHOD FOR PRODUCING AN ANODE FOR LITHIUM BATTERIES

(71) Applicant: HYDRO-QUÉBEC, Varennes (CA)

(72) Inventors: Kamyab AMOUZEGAR, Mont-Royal (CA); Dominic LEBLANC, Gentilly (CA); Andrea PAOLELLA, Montréal (CA); Abdelbast GUERFI, Brossard (CA); Shirin KABOLI, Montreal (CA); Patrick BOUCHARD, Shawinigan (CA); François LAROUCHE, Mont-Saint-Hilaire (CA); Nicolas DELAPORTE, Montréal (CA)

(73) Assignee: HYDRO-QUÉBEC, Varennes (CA)

(21) Appl. No.: 18/154,201

(22) Filed: Jan. 13, 2023

Related U.S. Application Data
(60) Provisional application No. 63/299,247, filed on Jan. 13, 2022.

(51) Int. Cl. H01M 4/62; H01M 4/04; H01M 10/052

(52) U.S. Cl. CPC H01M 4/628; H01M 4/0404; H01M 4/0454; H01M 10/052; H01M 2004/027

(57) ABSTRACT

There is provided a method for producing an anode for lithium batteries. The method comprises: providing a current collector, forming a layer of protective material thereon, depositing a lithiophilic material on the layer of protective material, and depositing a molten lithium material on the layer of lithiophilic material. The lithiophilic material and the molten lithium material subsequently react to form the anode active material. The current collector and/or at least one other layer of the anode may comprise a continuous 3D structure on a surface thereof. The protective material deposited on the current collector constitutes a barrier between the current collector and lithium in the anode active material, therefore formation of cracks in the current collector is avoided.

### CROSS REFERENCE TO RELATED APPLICATIONS

This application claims benefit of U.S. Provisional Patent Application No. 63/299,247 filed on Jan. 13, 2022. The content of this application is incorporated herein in its entirety by reference.

### FIELD OF THE INVENTION

The present invention relates generally to methods for producing anodes for lithium batteries. More specifically, the invention relates to a method for producing an anode, wherein the anode active material is formed following a reaction between a lithiophilic material and a lithium material in molten form or following deposit of the lithium material on a lithiophilic surface. The current collector and/or at least one other layer of the anode may comprise a continuous 3D structure.

### BACKGROUND OF THE INVENTION

Lithium metal, with a theoretical0 specific energy of 3860 mAh/g, constitutes a good anode material for an energy storage system (ESS) or battery, in comparison for example to a material such as graphite which has a theoretical specific energy of 372 mAh/g.

A thin foil of Li metal is needed to increase the energy density of the battery and to decrease the production cost of the anode. However, Li has a low mechanical strength and electronic conductivity (less than 5 times and 3 times compared to copper and aluminium, respectively). Accordingly, a thin free-standing Li is difficult to produce and to handle. It is known in the art to use a thin layer of Li deposited on a substrate made of a conductive material. Typically, a substrate also called current collector that has good mechanical properties and a good electronic conductivity, is selected. Even a layer of Li with a thickness as low as 4 to 5 microns on the substrate constitutes a better solution than using a free-standing Li.

Methods for depositing a thin layer of Li on a metal substrate are known in the art. Such methods include for example the physical vapour deposition (PVD) technique. However, several drawbacks are associated to PVD such as the fact that the deposition rate is rather low, and the overall technique is quite expensive.

Also, it has been observed that when a layer of Li is deposited on the current collector, an interaction occurs between Li and the conductive material, which leads to the formation of cracks in the current collector. This is described herein below in more detail. The formation of cracks in the current collector becomes particularly prevalent when a more desirable thinner current collector is used, and also when other deposition techniques are conducted, which involve the use of lithium at elevated temperatures.

There is still a need for efficient and cost-effective methods for producing anodes for lithium batteries. In particular, there is a need for such methods which allow for other Li deposition techniques than PVD, and which do not lead to the current collector being damaged.

### SUMMARY OF THE INVENTION

The inventors have designed and performed a method for producing an anode for lithium batteries. The method comprises: providing a current collector, forming a layer of protective material thereon, depositing a lithiophilic material on the layer of protective material, and depositing a molten lithium material on the layer of lithiophilic material. The lithiophilic material and the molten lithium material subsequently react to form the anode active material. The current collector and/or at least one other layer of the anode may comprise a continuous 3D structure on a surface thereof. The method may also comprise a plasma treatment which may lead to the formation of a lithiophilic surface. The protective material deposited on the current collector constitutes a barrier between the current collector and lithium in the anode active material, therefore formation of cracks in the current collector is avoided.

In embodiments of the invention, deposit of the lithiophilic material on the protective layer is followed by a plasma treatment leading to a plasma treated lithiophilic material, prior to depositing the molten lithium material.

In embodiments of the invention, the protective layer is subjected to a plasma treatment leading to the formation of a lithiophilic surface, on which the molten lithium material is deposited.

The plasma treatment may be a thermal atmospheric pressure plasma or any other suitable plasma treatments.

In embodiments of the invention, the current collector is provided with a continuous 3D structure formed on its surface. In addition, at least one other layer of the anode including the protective layer, the lithiophilic surface, the layer of the anode active material, and the layer of surface treatment agent may comprise a continuous 3D structure. The continuous 3D structure may be formed by electrochemical or chemical deposition of a conductive material on the surface.

Alternatively, regarding the current collector for example, the continuous 3D structure may be formed by providing some roughness at a surface thereof using a technique which may comprise a mechanical and/or a laser treatment, electrochemical oxidation, chemical etching, or any other suitable techniques.

In embodiments of the invention, the lithium material in molten form comprises lithium or an alloy thereof.

In embodiments of the invention, there is provided an anode that comprises a current collector, a layer of protective material deposited on the current collector, and a layer of anode active material which is formed following a reaction between a lithiophilic material and a lithium material in molten form or which is formed following deposit of the lithium material on a lithiophilic surface. In embodiments of the invention, the anode is single-sided, or the anode is double-sided. In embodiments of the invention, the current collector has a thickness between about 4 to about 5 μm.

In embodiments of the invention, there is provided an apparatus adapted for conducting the method described herein to produce the anode described herein.

In embodiments of the invention, the lithium battery is a lithium-ion battery or an all-solid-state battery.

The invention thus provides the following in accordance with aspects thereof:
(1). A method for producing an anode for a lithium battery, comprising: a) providing a current collector; b) depositing a layer of protective material on a surface of the current collector to obtain a protected current collector; c) depositing a layer of a lithiophilic material on a surface of the protected current collector; and d) depositing a layer of lithium material in molten form on the layer of lithiophilic material, whereby the lithiophilic material reacts with the molten lithium material to form a layer of anode active material.
(2). A method for producing an anode for a lithium battery, comprising: a) providing a current collector; b) depositing a layer of protective material on a surface of the current collector to obtain a protected current collector; c) depositing a layer of a lithiophilic material on the layer of protective material, then c1) subjecting the layer of lithiophilic material to a plasma treatment to obtain a layer of plasma treated lithiophilic material; and d) depositing a layer of lithium material in molten form on the layer of plasma treated lithiophilic material, whereby the lithiophilic material reacts with the molten lithium material to form a layer of anode active material.
(3). A method for producing an anode for a lithium battery, comprising: a) providing a current collector; b) depositing a layer of protective material on a surface of the current collector to obtain a protected current collector; c1) subjecting the protected current collector to a plasma treatment to obtain a plasma treated protected current collector having a lithiophilic surface; and d) depositing a layer of lithium material in molten form on the lithiophilic surface, thereby forming a layer of anode active material.
(4). The method according to any one of (1) to (3) above, further comprising a1) forming a continuous 3D structure on a surface of the current collector to obtain a textured current collector prior to conducting step b).
(5). The method according to any one of (1) to (4) above, further comprising b1) forming a continuous 3D structure on surface of the protected current collector to obtain a textured protected current collector prior to conducting step c) or step c1).
(6). The method according to any one of (1) to (5) above, further co0mprising e) depositing a layer of a surface treatment agent on the layer of anode active material formed.
(7). The method according to any one of (1) to (6) above, further comprising d1) forming a continuous 3D structure on a surface of the anode active material layer prior to conducting step e).
(8). The method according to any one of (1) to (7) above, further comprising e1) forming a continuous 3D structure on a surface of the surface treatment agent layer.
(9). The method according to any one of (1) to (8) above, wherein steps a1), b), b1), c), c1), d), d1), e), and e1) are performed on both sides of the current collector and a double-sided anode is produced, optionally steps a1), b), b1), c), c1), d), d1), e), and e1) are all conducted on one side of the current collector, then on the other side of the current collector; optionally each of steps a1), b), b1), c), c1), d), d1), e), and e1) is performed simultaneously on one side of the collector then on the other side of the current collector.
(10). The method according to any one of (1) to (9) above, wherein steps a1) and b1) each independently comprises an electrochemical deposition of a conductive material on the surface of the current collector or on the surface of the protected current collector, optionally the conductive material is the same material as the current collector; optionally the conductive material is a different material than the current collector.
(11). The method according to any one of (1) to (10) above, wherein steps a1) and b1) each independently comprises providing some roughness on the surface of the current collector or on the surface of the protected current collector, optionally steps a1) and b1) each independently comprises a mechanical and/or a laser treatment, electrochemical oxidation, chemical etching, or any other suitable techniques.
(12). The method according to any one of (1) to (11) above, wherein step b) comprises electrochemical deposition, electroless plating, or any other suitable techniques.
(13). The method according to any one of (1) to (12) above, wherein step c) comprises an electrochemical oxidation or reduction, or any other suitable techniques.
(14). The method according to any one of (1) to (13) above, wherein the plasma treatment at step c1) is a thermal atmospheric pressure plasma.
(15). The method according to any one of (1) to (14) above, wherein step d) comprises infiltration methods, wave soldering, use of heated nozzles, anilox rolls, or any other suitable techniques.
(16). The method according to any one of (1) to (15) above, wherein at least one drying step is performed after any of steps a1), b), b1), c), d), and e).
(17). The method according to any one of (1) to (16) above, wherein the lithium material in molten form is at a temperature between about 180° C. and about 400° C., optionally the lithium material in molten form is at a temperature of about 210° C.
(18). The method according to any one of (1) to (17) above, wherein the current collector comprises a material which is Cu, Al, Ni, Ti, C, stainless steel, a conductive polymer, or a combination thereof, optionally the current collector comprises Cu, Al, or carbon-coated Al.
(19). The method according to any one of (1) to (18) above, wherein the protective material comprises Ni, Co, Cr, Fe, Ti, or a combination thereof, optionally the protective material comprises Ni.
(20). The method according to any one of (1) to (19) above, wherein the lithiophilic material comprises CuO, Cu₂O, ZnO, MnO₂, SnO₂, Cu, Au, Mg, Al, In, B, Zn, Sn, Si, SiO₂, SiOₓ, a metal fluoride, a metal boride, or a combination thereof, optionally the lithiophilic material comprises ZnO, Zn, or Sn.
(21). The method according to any one of (1) to (20) above, wherein the lithiophilic surface has a 3D structure, optionally the lithiophilic surface comprises Ni.
(22). The method according to any one of (1) to (21) above, wherein the lithium material in molten form comprises lithium or an alloy thereof, optionally the lithium material in molten form is lithium metal, optionally the lithium alloy is a binary alloy such as Li—Mg, Li—Al, Li—Na, Li—Si, Li—Sn, Li—Zn, Li—Ag, Li—K, Li—B, Li—In, or any other suitable lithium binary alloys; or the lithium alloy is a ternary alloy such as Li—Al—Na, Li—Mg—Na, Li—Al—Si, Li—Mg—Si, or a ternary alloy comprising elements such as Cu, Zn, Sn, Ca, Sr, or any other suitable lithium ternary alloys.
(23). The method according to any one of (1) to (22) above, wherein the surface treatment agent comprises Ag, Zn, Al, SiOₓ, Sn, Si, Li₂CO₃, LiF, carbon black, carbon nano fiber, graphene, or any other suitable surface treatment agents.
(24). The method according to any one of (1) to (23) above, wherein the lithium battery is a lithium-ion battery or an all-solid-state battery.
(25). An anode produced by the method as defined in any one of (1) to (24) above.
(26). An anode for a lithium battery, comprising: a current collector; a layer of protective material deposited on the current collector; and an anode active material which is formed following a reaction between a lithiophilic material and a lithium material in molten form, optionally the anode active material is formed following a deposit of the lithium material on a lithiophilic surface.
(27). The anode according to (25) or (26) above, wherein there is substantially no physical or chemical interaction between the current collector and the anode active material.
(28). The anode according to any one of (25) to (27) above, which is single-sided or double-sided.
(29). The anode according to any one of (25) to (28) above, wherein the current collector has a thickness between about 4 to about 5 μm.
(30). An apparatus adapted for producing the anode as defined in any one of (25) to (29) above.
(31). Use of the anode as defined in any one of (25) to (29) above, in the manufacture of a lithium battery.
(32). A method of manufacturing a lithium battery, comprising using of the anode as defined in any one of (25) to (29) above.
(33). A lithium battery comprising the anode as defined in any one of (25) to (29) above, optionally the lithium battery is a lithium-ion battery or an all-solid-state battery.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the appended drawings:

FIG. 1: EDS analysis of the cross-section of a sample composed of a copper current collector foil that has been covered with a 50 nm thick of Zn coating as lithiophilic material, and put in contact with molten Li. A) an SEM image of the cross-section; and B) the EDS line scan analysis across the cross-section as a function of the depth.

FIG. 2: Anode according to the invention illustrating a single-sided anode and a double-sided anode.

FIG. 3: The aspect of cupper foil at the back side of each sample as a function of time for Cu—Zn—Li and Cu—Ni—Zn—Li.

FIG. 4: SEM and EDS analyses of the back side of Cu—Ni—Zn—Li and Cu—Zn—Li samples after 30 seconds of contact with molten Li.

FIG. 5: Variation of the contact angle of molten Li on Cu—Ni as well as Cu—Ni—Zn substrates of different Zn layer thicknesses.

FIG. 6: Variation of the contact angle of molten Li on Cu—Ni—Zn substrates of different Zn layer thicknesses after 10 and 30 seconds of contact.

FIG. 7: Variation of the contact angle of molten Li on Cu—Ni as well as Cu—Ni—Sn substrates of different Sn layer thicknesses.

FIG. 8: Photography of the surface of the Cu foil sample after Ni electrodeposition (a), ZnO electrodeposition (b), and Li application (c).

FIG. 9: Variation of the contact angle for Cu—Ni and Cu—Ni—Sn (40 nm) with molten Li and that of Cu—Ni—Sn (40 nm) with Li—Mg alloy.

FIG. 10: SEM image of the sample (after cryofracture) showing a thin layer of Li with a thickness of 5 μm with a good uniformity (variation below ±1 μm).

FIG. 11: EDS line scan analysis across the cross section as a function of the depth of the Cu—Ni—Sn—Li—Zn sample.

FIG. 12: Lithiophilic activity of the different Cu—Ni substrates expressed as the total surface area of the molten Li after two minutes of spread time.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein the term “textured current collector” refers to a current collector which has at least one surface with a continuous 3D structure formed thereon. The continuous 3D structure may be formed by electrochemical deposition of a conductive material, or by a technique comprising a mechanical and/or laser treatment, electrochemical oxidation (dissolution), chemical etching, or any other suitable techniques. It should be noted that the term “textured” is also used herein in connection with any other layer of the anode which comprises a continuous 3D structure. Such layer is for example the protective layer, the layer of active anode material, and the layer of surface treatment agent.

As used herein the term “lithiophilic surface” refers to a surface which has an affinity for lithium. The surface may be a surface of the current collector having a protective material thereon. Also, the surface may comprise a continuous 3D structure. The lithiophilic property may be conferred to the surface upon a plasma treatment.

The inventors have designed and performed a method for producing an anode for lithium batteries.

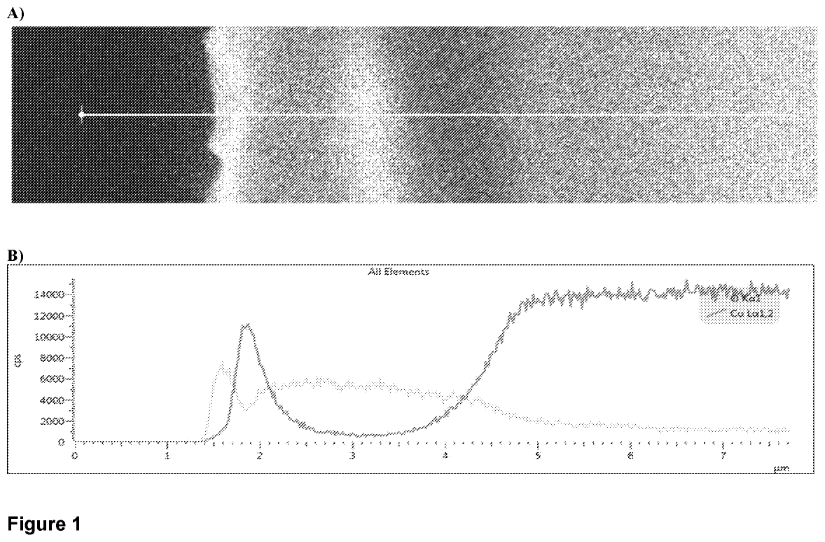

Our data confirm that when molten Li metal is applied to a Cu or Al foil (even at temperatures as low as 210° C.), the surface of the current collector metal starts forming an alloy and once the applied layer of molten Li solidifies, fragments of the current collector material can be found inside the Li layer or on its surface. FIG. 1 shows the EDS analysis of the cross-section of a sample composed of a copper current collector foil that had been covered with a 50 nm thick of Zn coating as lithiophilic material and put in contact with molten Li. FIG. 1A is a SEM image of the cross-section, and FIG. 1B corresponds to the EDS line scan analysis across the cross-section as a function of the depth. The Si signal is due to the resin used to prepare the sample for the cryo-microtomy and detection of C signal is normal to see in this type of analysis due to the inevitable presence of contamination. The signal from oxygen gives an idea of where the top of deposited Li layer starts (at around 1.4 μm) and where it ends (at around 4.8 μm). As can be seen, a very strong signal from copper is detected at the surface of the deposited Li layer showing that fragments of Cu have detached from the Cu foil surface and have formed intermetallic particles on the upper section of the Li layer.

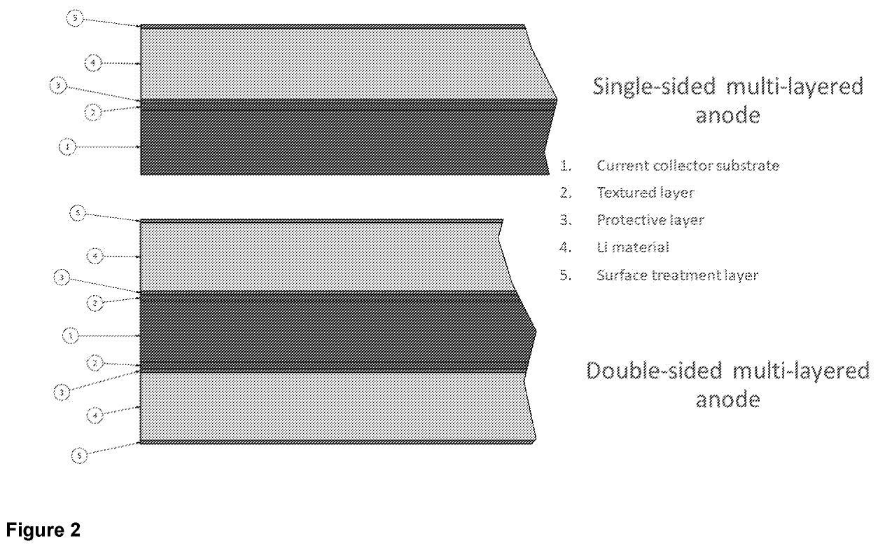

It should be noted that in FIG. 2, reference numerals 1-5 identify element of the anode as follows: 1—current collector substrate, 2—textured layer, 3—protective layer, 4—Li material, and 5—surface treatment layer.

In the cases where the current collector thickness is very small, as the result of the interaction between the Li layer and the current collector surface, important holes start to appear in the current collector material. This may be an important disadvantage especially when the objective is to use very thin current collector foils (for example 4-5 μm) in order to minimize the production cost of the anode and to maximize the specific and volumetric energy density of the battery.

It should be noted that different categories of lithiophilic materials can be deposited on the barrier layer using electrochemical methods under controlled conditions (in terms of thickness and morphology of the deposit) in a time effective and scalable electrochemical set up. Depending on the nature of the lithiophilic material, at the stage of its deposition, the current collector may receive a cathodic current (becoming the cathode electrode during the lithiophilic deposition) or an anodic current. Accordingly, the current collector can be used as a cathode (for the deposition of elements such as Zn, Sn, Si, metallic borides, or even oxides such as ZnO, MnO₂, or SnO₂), or as anode (for deposition or formation of compounds such as CuO, Cu₂O, SnO₂, or MnO₂).

The advantages of the electrochemical deposition compared to other approaches are as follows:
Compared to PVD, it is more cost effective and much faster
Compared to wet chemistry and thermal treatments, the thickness is better controlled and is more precise and the process is much faster (several seconds or minutes instead of several hours)
It is easier to control the exact areas where the lithiophilic material is deposited which in turn allows a better control of where the Li layer will be deposited
The scale up of a roll-to-roll electrochemical lithiophilic deposition is easier and more cost effective.

### EXAMPLE 1

Two sets of current collectors were prepared using a 5 μ thick copper foil. In one set a 40 nm layer of Zn was deposited on the copper foil in an electrolytic cell to prepare Cu—Zn foil samples. For the second set, a layer of 300 nm of Ni (the thickness was estimated by using a quartz microbalance crystal) was deposited electrochemically before the deposition of the 40 nm Zn layer to prepare Cu—Ni—Zn foil samples. In order to evaluate the effect of the interaction between molten Li and Cu foil, in the presence of a lithiophilic material such as Zn, the two sets of prepared samples were tested by being put in contact with the same quantity of molten Li under the same conditions. For each test (carried out in an Ar glove box equipped with purification units to insure H₂O, O₂ and N₂ levels below 1 ppm), approximately 0.1 g of molten Li (prepared by heating Li to 250° C. in a stainless steel syringe and applied using a mechanically controlled piston) was deposited on the surface of the sample (having a surface area of around 14 cm²) placed on a sample holder that assured the flatness of the sample and that allowed to control its temperature at around 230° C. Once the Li droplet deposited, it started to extend over the sample surface due to the lithiophilic action of the Zn layer. Each sample was allowed to be in contact with the molten Li droplet for a certain time interval (4 times of 10, 30, 60, and 120 seconds were tested) and then the sample was allowed to cool down to room temperature.

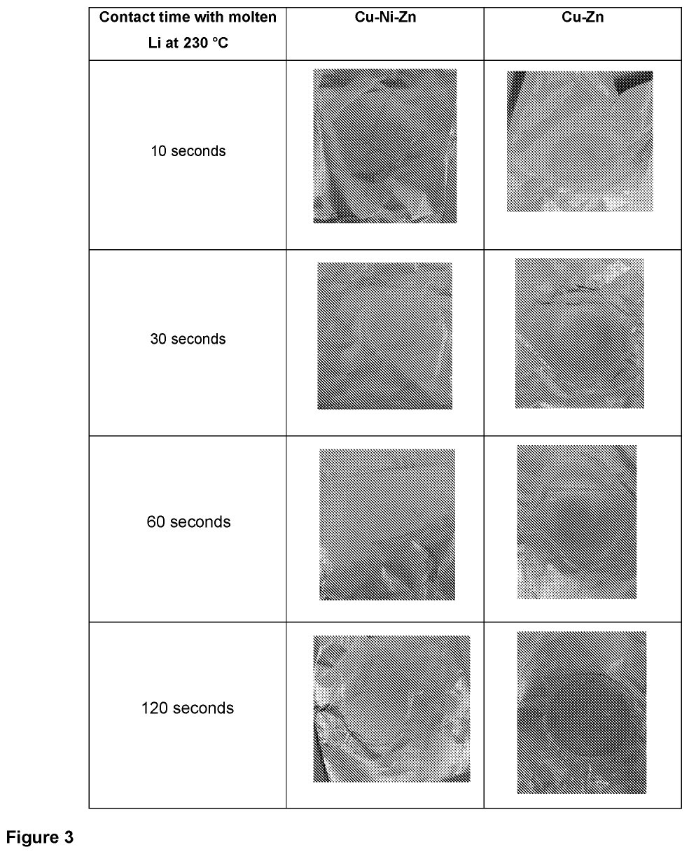

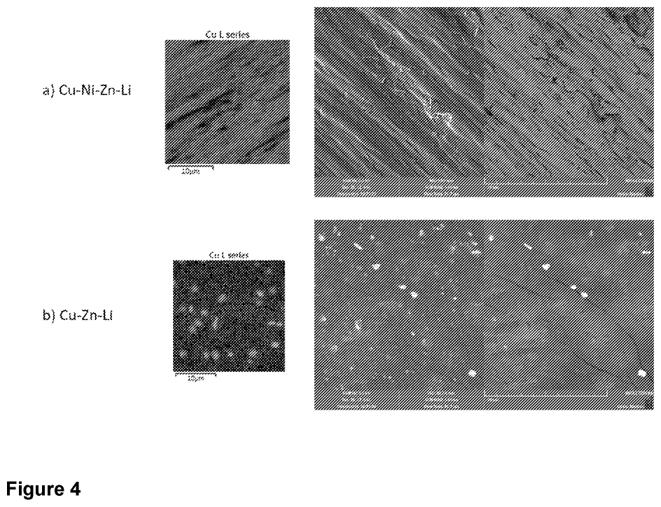

FIG. 3 shows the aspect of cupper foil at the back side of each sample. As it may be seen, the Cu—Ni—Zn samples do not show any sign of being affected by the contact with molten Li, no matter the duration of the contact. However, in the case of Cu—Zn samples, even after 10 seconds of contact with molten Li, there is visible signs of the appearance of a darker zone in the same area as where the Li was applied. After 30 seconds of contact, the area corresponding to Li application shows a clear gray area in the back in the case of Cu—Zn. FIG. 4 shows an SEM image and an EDS analysis of the back of the Cu—Zn sample after 30 seconds of contact with Li. It may be seen that most of Cu is attacked, and Cu is left only as small clusters rather than an intact foil. The effect of interaction with molten lithium become even more important after 60 and 120 seconds for Cu—Zn—Li samples as it may be seen in FIG. 3. As seen in FIG. 3 and FIG. 4, the deposition of the Ni layer on the Cu foils protects well the Cu foil from its interaction with molten Li.

### EXAMPLE 2

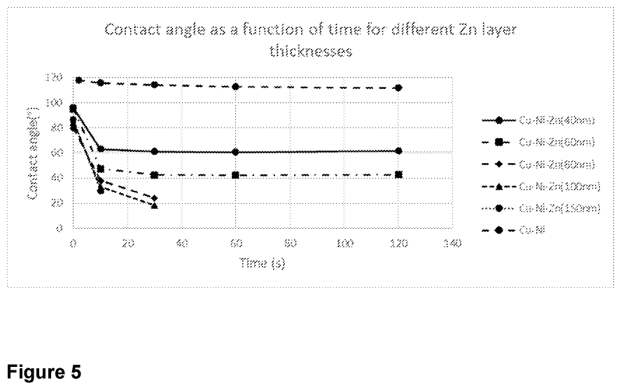

In order to evaluate the effect of the thickness of the Zn layer on its lithiophilic property, five square samples of 5 μm Cu foils (14 cm²) were electroplated with 300 nm of Ni followed by a Zn layer having a thickness of 40, 60, 80, 100, or 150 nm. The same set up mentioned in Example 1 was used to deposit controlled droplets of molten Li (0.1 g) and measure the contact angle of the droplets as a function of time. FIG. 5 shows the variation of the contact angle of molten Li on Cu—Ni as well as Cu—Ni—Zn substrates of different Zn layer thicknesses.

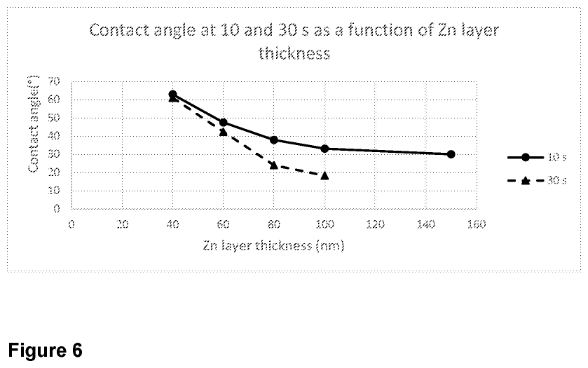

As can be seen in FIG. 5, when the Cu foil is covered only with a protection layer of 300 nm of electrodeposited Ni, the surface shows no lithiophilicity towards Li with a measured contact angle of around 118° after 2 seconds. The contact angle remained practically unchanged reaching 112° after 120 seconds. On the contrary, the electrodeposition of only 40 nm of Zn on the Cu—Ni surface resulted in a much lower contact angle of 61° after 30 seconds showing the lithiophilic effect of the Zn deposit. It can also be seen that increasing the thickness of the Zn deposit results in even lower contact angle values. To better show the effect of Zn thickness on the lithiophilic effect, the same data in FIG. 5 are presented in FIG. 6 for contact angle times of 10 and 30 seconds on different Cu—Ni—Zn samples. As can be seen, contact angle values as low as 18° are obtained after 30 seconds of contact between molten Li and Cu—Ni—Zn having a Zn layer of 150 nm in thickness.

### EXAMPLE 3

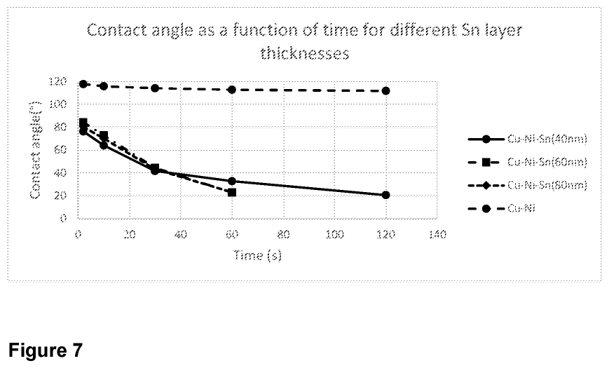

To evaluate the lithiophilic effect of Sn, three square samples of 5 μm Cu foils (14 cm²) were electroplated with 300 nm of Ni followed by a Sn layer having a thickness of 40, 60, or 80 nm. The same set up mentioned in Example 1 was used to deposit controlled droplets of molten Li (0.1 g) and measure the contact angle of the droplets as a function of time. FIG. 7 shows the variation of the contact angle of molten Li on Cu—Ni as well as Cu—Ni—Sn substrates of different Sn layer thicknesses. As in the case for Zn, Cu—Ni—Sn samples also show a very good lithiophilic effect when compared to Cu—Ni with no lithiophilic agent on the surface. In the case of Sn, all three samples of 40, 60, and 80 nm showed similar lithiophilic activities as it may be observed in FIG. 7.

### EXAMPLE 4

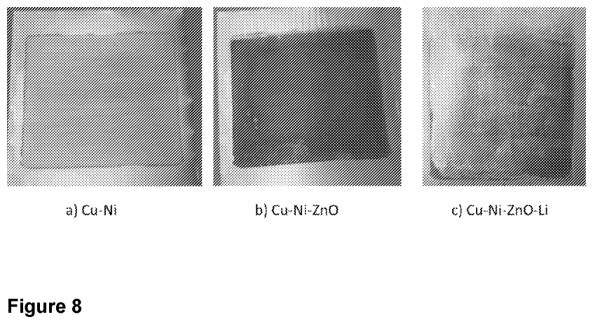

To evaluate the lithiophilic effect of ZnO, a sample of Cu—Ni—ZnO was prepared by electrodepositing a thin layer of ZnO on a Cu foils (14 cm²) having a 300 nm electrodeposited layer of Ni protection. The ZnO layer was electrodeposited by using Cu—Ni foil as a cathode in an electrolysis cell containing a 0.1 M Zn(NO₃)₂ solution as electrolyte and a Zn plate as anode. The electrolysis was carried out at a current density of 5 mA/cm² and a temperature of 62° C. for a duration of 36 seconds. The thickness of the ZnO layer is estimated to be around 30 nm. The sample was then placed in a glove box similar to the one mentioned in Example 1 and heated to 250° C. on a heating plate. Li was then melted on the surface of sample by placing a Li rod made of extruded Li. Once the Li had melted, the excess Li was removed using a hand operated blade made of high temperature silicon. FIG. 8 shows photography of the surface of the Cu foil sample after Ni electrodeposition (a), ZnO electrodeposition (b), and Li application (c). As can be seen, the molten Li adheres only on the area covered by electrodeposited ZnO showing the efficacy of ZnO as a lithiophilic material for molten Li application.

### EXAMPLE 5

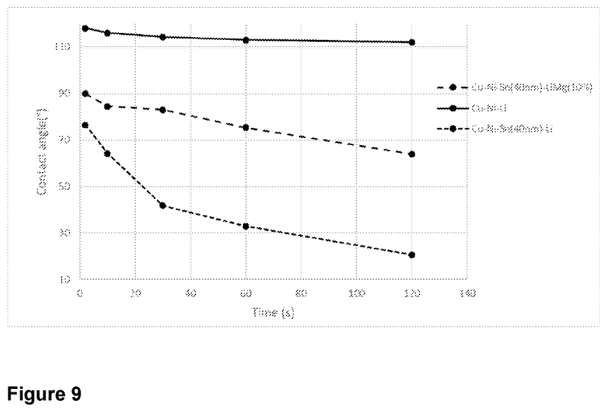

To evaluate the lithiophilic effect of Sn using a Li alloy, the same type of experiment mentioned in Example 3 was carried out using Cu—Ni—Sn (40 nm) and a Li—Mg alloy having aa weight Li:Mg ratio of 90%-10%. The variation of the contact angle for Cu—Ni and Cu—Ni—Sn (40 nm) with molten Li and that of Cu—Ni—Sn (40 nm) with Li—Mg alloy is presented in FIG. 9. As can be seen, although the contact angle values of Li—Mg (10%) on Sn (40 nm) are lower than those of Li on Sn (40 nm), Sn (40 nm) still shows a clear lithiophilic activity towards Li—Mg (10%) when its contact angle values are compared to those of Li on Cu—Ni without Sn lithiophilic layer.

### EXAMPLE 6

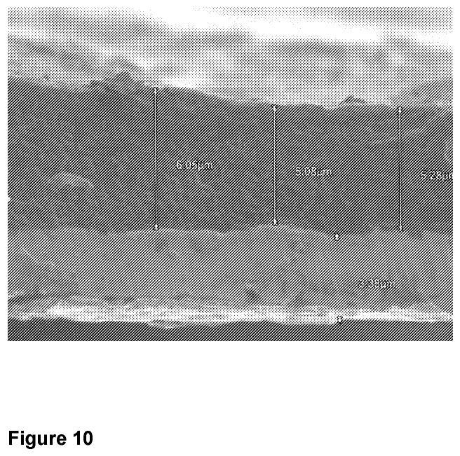

This example shows the feasibility of using an easily scalable method for applying a thin and uniform layer of Li on a current collector such as a 5 μm Cu foil using molten Li. A sample of 5 μm Cu foils (130 cm²) was electroplated with 300 nm of Ni followed by a Sn layer having a thickness of 40 nm. The sample was then applied manually at a constant speed of 2 cm/s on the top surface of an anilox roll immersed partially in a reservoir containing molten Li at a temperature of 260° C. The anilox roll had a length of 700 mm and a diameter of 19 mm. It presented inverted pyramidal features (20 pyramids per 25 mm) and a depth of around 400 μm in each pyramid. An SEM image of the sample (after cryofracture) is showed in FIG. 10. A thin layer of Li with a thickness of 5 μm with a good uniformity (variation below ±1 μm) was obtained.

### EXAMPLE 7

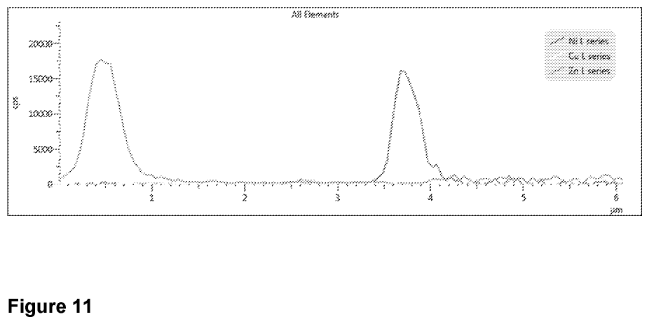

In order to show the feasibility of the deposition of a surface treatment layer on the deposited Li layer of the proposed Li anode material, a Cu—Ni—Sn—Li sample similar to that produced in Example 6 was treated by DC sputter. An average target value of 50 nm of Zn was deposited by applying a DC current of 50 mA on a Zn target of 99.9% purity under a vacuum of 0.008 mbar and using highly pure Ar (grade 6.0; 99.9999% purity). FIG. 11 shows the EDS analysis of the cross section of the sample. The EDS line scan analysis across the cross-section as a function of the depth shows the copper current collector foil (not the entire thickness of 5 μm is shown), the Ni protection layer between 3.5 and 4.0 μm, the Li layer between 0.5 and 3.5 μm (the Li signal is absent in this EDS due to the very weak signal from Li) as well as the presence of Zn layer on top the Li layer.

### EXAMPLE 8

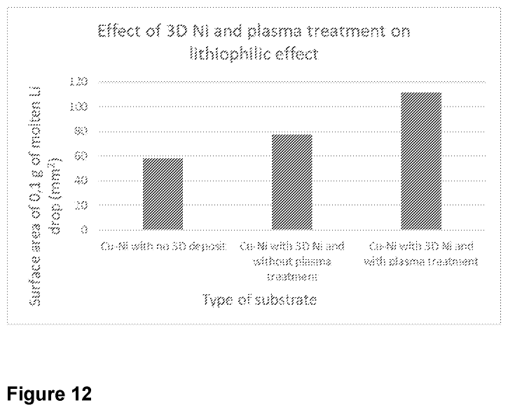

Two square samples of 5 μm Cu foils (14 cm²) were electroplated with 300 nm of smooth Ni followed by the electrodeposition of a rough Ni layer having a 3D effect. Contrary to the smooth Ni layer, the 3D layer was electrodeposited at a high current density of 2000 mA/cm² and a total charge of 15 C/cm² using an NiSO₄, NH₄Cl solution as electrolyte. One of the samples with the Ni3D was then treated with non thermal atmospheric pressure plasma using a Plasma Etch handheld plasma wand. The device had an output of 18 W and the sample was treated using the nearfield module (for electrically conducting materials) at a distance of 2 mm and at a speed of around 10 mm/s. The same set up described in Example 1 was used to deposit controlled droplets of molten Li (0.1 g) on Cu—Ni as well as Cu—Ni-3DNi with and without plasma treatment. Due to the roughness of the Cu—Ni-3DNi samples and the fast spreading of the molten Li drop, it was challenging to do a comparison of the lithiophilic activity using the contact angle parameter. In this case, the molten Li drop was allowed to spread on the surface for two minutes and the total surface area of the spread Li was measured and used as an indication of lithiophilic activity of the substrate surface. The results are presented in FIG. 12. As can be seen, the electrodeposition of the rough 3D Ni on the substrate results in an increase in the lithiophilicity of the surface compared to Cu foil covered only with the smooth Ni layer. The plasma treatment allowed to increase further the lithiophilicity of the Ni3D substrate.

As will be understood by a skilled person, the method according to the invention comprises the following steps: a) providing a current collector; b) depositing a layer of protective material on the surface of the current collector; c) depositing a layer of a lithiophilic material on the layer of protective material; and d) depositing a layer of lithium material in molten form on a layer of the lithiophilic material, whereby the lithiophilic material reacts with the molten lithium material to form the anode active material. In embodiments of the invention, the method comprises a subsequent step e) depositing a layer of a surface treatment agent on the anode active material formed. In embodiments of the invention, a step a1) forming a continuous 3D structure on a surface of the current collector to obtain a textured current collector is conducted prior to conducting step b).

In embodiments of the invention, step c) is followed by a step c1) which is a plasma treatment of the lithiophilic material to obtain a plasma treated lithiophilic material. Then step d) is conducted. In other embodiments, step c) is altogether replaced by step c1). In such embodiments, the plasma treatment is conducted on the protective layer leading to the formation of a lithiophilic surface; preferably, the protective layer comprises a continuous 3D structure and/or the protective layer comprises Ni. The plasma treatment may be a thermal atmospheric pressure plasma or any other suitable plasma treatments.

In embodiments of the invention, a continuous 3D structure may be formed on a surface of the anode active material layer and/or a surface of the surface treatment agent layer. Accordingly, a step d1), forming a continuous 3D structure on a surface of the anode active material layer, is conducted right after step d); and/or a step e1), forming a continuous 3D structure on a surface of the surface treatment agent layer, is conducted right after step e).

The step of forming a continuous 3D structure on a surface of the current collector to obtain a textured current collector or on any other layer of the anode, may comprise providing some roughness on the surface of the current collector. This step may comprise a mechanical and/or a laser treatment, electrochemical oxidation, chemical etching, or any suitable techniques known to a skilled person. In embodiments of the inventions, the continuous 3D structure may be conferred to the anode active material layer and/or the surface treatment layer.

The step of depositing a layer of protective material on the surface of the current collector, step b), may comprise electrochemical deposition, electroless plating, or any other suitable techniques known to a skilled person.

The step of depositing a layer of a lithiophilic material on the layer of protective material, step c), may comprise an electrochemical oxidation or reduction, or any other suitable techniques known to a skilled person.

The step of depositing a layer of lithium material in molten form on the layer of lithiophilic material or on the lithiophilic surface, step d), may comprise infiltration methods, wave soldering, use of heated nozzles, anilox rolls, or any other suitable techniques.

As will be understood by a skilled person, the invention also provides for an anode produced by the method according to the invention. The anode may be single-sided or double-sided. Also, the anode may have a thickness between about 4 to about 5 μm.

As will be understood by a skilled person, the invention further provides for an apparatus adapted to conduct the method according to the invention which produces the anode. Use of the anode in the manufacture of a lithium battery as well as the manufacturing method for producing a lithium battery comprising using of the anode are also within the scope of the invention. Moreover, the invention provides for a lithium battery comprising the anode. The lithium battery may be a lithium-ion battery or an all-solid-state battery.

As will be understood by a skilled person, other variations and combinations may be made to the various embodiments of the invention as described herein above.

The scope of the claims should not be limited by the preferred embodiments set forth in the examples; but should be given the broadest interpretation consistent with the description as a whole.

The description refers to a number of documents, the contents of which are herein incorporated by reference in their entirety.

1. A method for producing an anode for a lithium battery, comprising:
a) providing a current collector;
b) depositing a layer of protective material on a surface of the current collector to obtain a protected current collector;
c) depositing a layer of a lithiophilic material on a surface of the protected current collector; and
d) depositing a layer of lithium material in molten form on the layer of lithiophilic material, whereby the lithiophilic material reacts with the molten lithium material to form a layer of anode active material.

2. A method for producing an anode for a lithium battery, comprising:
a) providing a current collector;
b) depositing a layer of protective material on a surface of the current collector to obtain a protected current collector;
c) depositing a layer of a lithiophilic material on the layer of protective material, then
c1) subjecting the layer of lithiophilic material to a plasma treatment to obtain a layer of plasma treated lithiophilic material; and
d) depositing a layer of lithium material in molten form on the layer of plasma treated lithiophilic material, whereby the lithiophilic material reacts with the molten lithium material to form a layer of anode active material.

3. A method for producing an anode for a lithium battery, comprising:
a) providing a current collector;
b) depositing a layer of protective material on a surface of the current collector to obtain a protected current collector;
c1) subjecting the protected current collector to a plasma treatment to obtain a plasma treated protected current collector having a lithiophilic surface; and
d) depositing a layer of lithium material in molten form on the lithiophilic surface, thereby forming a layer of anode active material.

4. The method according to claim 1, further comprising e) depositing a layer of a surface treatment agent on the layer of anode active material formed.

5. The method according to claim 4, further comprising one or more of the following steps:
a1) forming a continuous 3D structure on a surface of the current collector to obtain a textured current collector prior to conducting step b);
b1) forming a continuous 3D structure on surface of the protected current collector to obtain a textured protected current collector prior to conducting step c) or step c1);
d1) forming a continuous 3D structure on a surface of the anode active material layer prior to conducting step e); and
e1) forming a continuous 3D structure on a surface of the surface treatment agent layer after step e) is conducted.

6. The method according to claim 5, wherein steps a1), b), b1), c), c1), d), d1), e), and e1) are performed on both sides of the current collector and a double-sided anode is produced,
optionally steps a1), b), b1), c), c1), d), d1), e), and e1) are all conducted on one side of the current collector, then on the other side of the current collector;
optionally each of steps a1), b), b1), c), c1), d), d1), e), and e1) is performed simultaneously on one side of the collector then on the other side of the current collector.

7. The method according to claim 5, wherein steps a1) and b1) each independently comprises an electrochemical deposition of a conductive material on the surface of the current collector or on the surface of the protected current collector,
optionally the conductive material is the same material as the current collector;
optionally the conductive material is a different material than the current collector.

8. The method according to claim 5, wherein steps a1) and b1) each independently comprises providing some roughness on the surface of the current collector or on the surface of the protected current collector,
optionally steps a1) and b1) each independently comprises a mechanical and/or a laser treatment, electrochemical oxidation, chemical etching, or any other suitable techniques.

9. The method according to claim 1, wherein step b) comprises electrochemical deposition, electroless plating, or any other suitable techniques.

10. The method according to claim 1, wherein step c) comprises an electrochemical oxidation or reduction, or any other suitable techniques.

11. The method according to claim 3, wherein the plasma treatment at step c1) is a thermal atmospheric pressure plasma.

12. The method according to claim 1, wherein step d) comprises infiltration methods, wave soldering, use of heated nozzles, anilox rolls, or any other suitable techniques.

13. The method according to claim 5, wherein at least one drying step is performed after any of steps a1), b), b1), c), d), d1), e), and e1).

14. The method according to claim 1, wherein the lithium material in molten form is at a temperature between about 180° C. and about 400° C.,
optionally the lithium material in molten form is at a temperature of about 210° C.

15. The method according to claim 1, wherein the current collector comprises a material which is Cu, Al, Ni, Ti, C, stainless steel, a conductive polymer, or a combination thereof,
optionally the current collector comprises Cu, Al, or carbon-coated Al.

16. The method according to claim 1, wherein the protective material comprises Ni, Co, Cr, Fe, Ti, or a combination thereof,
optionally the protective material comprises Ni.

17. The method according to claim 1, wherein the lithiophilic material comprises CuO, Cu₂O, ZnO, MnO₂, SnO₂, Cu, Au, Mg, Al, In, B, Zn, Sn, Si, SiO₂, SiOₓ, a metal fluoride, a metal boride, or a combination thereof,
optionally the lithiophilic material comprises ZnO, Zn, or Sn.

18. The method according to claim 1, wherein the lithiophilic surface has a 3D structure,
optionally the lithiophilic surface comprises Ni.

19. The method according to claim 1, wherein the lithium material in molten form comprises lithium metal or an alloy thereof.

20. The method according to claim 1, wherein the surface treatment agent comprises Ag, Zn, Al, SiOₓ, Sn, Si, Li₂CO₃, LiF, carbon black, carbon nano fiber, graphene, or any other suitable surface treatment agents.

21. The method according to claim 1, wherein the lithium battery is a lithium-ion battery or an all-solid-state battery.

22. An anode produced by the method according to claim 1.

23. An anode for a lithium battery, comprising:
a current collector;
a layer of protective material deposited on the current collector; and
an anode active material which is formed following a reaction between a lithiophilic material and a lithium material in molten form,
optionally the anode active material is formed following a deposit of the lithium material on a lithiophilic surface.

24. The anode according to claim 23, wherein:
there is substantially no physical or chemical interaction between the current collector and the anode active material; and/or
the current collector has a thickness between about 4 to about 5 μm.

25. An apparatus adapted for producing the anode according to claim 23.

26. A method of manufacturing a lithium battery, comprising using of the anode according to claim 23.

27. A lithium battery comprising the anode according to claim 23,
optionally the lithium battery is a lithium-ion battery or an all-solid-state battery.

28. The method according to claim 1, wherein the lithium material in molten form comprises a binary alloy with lithium and one of the following: Mg, Al, Na, Si, Sn, Zn, Ag, K, B, or In.

29. The method according to claim 1, wherein the lithium material in molten form comprises a ternary alloy with lithium and any two of the following: Al, Na, Mg, Si, Cu, Zn, Sn, Ca, or Sr.

30. The anode according to claim 23, wherein the anode active material is present on two or more sides of the current collector.
